(19) United States
(12) Patent Application Publication
(10) Pub. No.: US 2006/0020909 A1
(43) Pub. Date: Jan. 26, 2006

(54) Managing user tasks during a project

(76) Inventor: Aurobinda Pradhan, Bangalore (IN)

Correspondence Address: FISH & RICHARDSON, P.C., PO BOX 1022, MINNEAPOLIS, MN, 55440-1022, US

(21) Appl. No.: 10/894,790

(22) Filed: Jul. 20, 2004

(51) Int. Cl. G06F 9/44

(52) U.S. Cl. 717/101

(57) ABSTRACT

A method of managing user tasks during a project may comprise displaying a checklist on a graphical user interface in a computer system, the checklist being used as an instruction guide for a user to perform predefined tasks during a project, receiving, in the computer system, a first user input that is associated with one of the predefined tasks and that includes performance data for the associated predefined task, and storing the performance data in the computer system, the performance data being stored in association with the associated predefined task. The graphical user interface may include status indicator(s) for the tasks. The user may skip one or more tasks. When the user is done with the tasks, the user may be prompted for additional information relating to the project.

### TECHNICAL FIELD

This description relates to managing predefined user tasks during a project.

### BACKGROUND

There are many situations where a checklist can be helpful. For example, a person may advantageously follow a checklist in performing physical or mental operations, such as performing service, repair, diagnosis, analysis, assistance, inspection, maintenance, inventory management, to name just a few examples. A checklist may ensure that important tasks are performed as instructed.

Moreover, a person may wish to document which steps of the checklist have been performed. This may be useful when a supervisor wants to ascertain that the person knows which steps to perform. The documentation may also be used in tracking the person's work routine for purposes of quality control or preparing invoices.

Existing systems may not offer a convenient way to manage user tasks. There may not be a convenient instruction guide for the user to follow. For example, existing systems may have a graphical user interface (GUI) that is not very user friendly. Moreover, functionality for entering performance data may be absent or difficult to use.

### SUMMARY

The invention relates to managing user tasks during a project. In a first general aspect, a method comprises displaying a checklist on a graphical user interface in a computer system. The checklist is used as an instruction guide for a user to perform predefined tasks during a project. A first user input is received in the computer system. The first input is associated with one of the predefined tasks and includes performance data for the associated predefined task. The performance data is stored in the computer system in association with the associated predefined task.

In selected embodiments, a second input associated with another one of the predefined tasks is received, the second user input indicating that the user skips the other one of the predefined tasks.

In selected embodiments, there is displayed a status indicator for the associated predefined task. The computer system can receive multiple performance data portions for the associated predefined task, and the status indicator may be associated with at least one of the performance data portions.

In selected embodiments, a second user input is received after receiving the first user input, the second user input indicating that the user is done performing the predefined tasks. Upon receiving the second user input, there may be displayed a data entry area where the user can enter additional information relating to performing the predefined tasks.

In selected embodiments, the performance data includes one selected from the group consisting of: time entry data, material consumption data, and combinations thereof.

In selected embodiments, the project relates to at least one selected from the group consisting of: service, repair, performing diagnosis, performing analysis, assistance, inspection, maintenance, inventory management, and combinations thereof.

In a second general aspect, a graphical user interface includes a checklist area that identifies predefined tasks. The checklist area is used as an instruction guide for a user to perform the predefined tasks during a project. The graphical user interface includes a performance data area that displays performance data for one of the predefined tasks. The performance data is entered by the user for storage in association with the one of the predefined tasks.

In selected embodiments, the graphical user interface further includes a status indicator for each of the predefined tasks. The status indicator can be updated upon the user confirming performance any of the predefined tasks. The graphical user interface may includes multiple status indicators for each of the predefined tasks. Each of the status indicators is associated with a portion of the performance data.

The systems and techniques described herein may provide any or all of the following advantages: improving management of user tasks; improving user performance of predefined tasks; improving documentation of performed user tasks; and making projects more efficient and foreseeable.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 schematically shows a person using an embodiment of an inventive GUI during a project;

FIGS. 2A-D are examples of the GUI shown in FIG. 1;

FIG. 3 is a flow chart of an embodiment of the inventive method; and

FIG. 4 is a block diagram of a general computer system.

Like reference numerals in the various drawings indicate like elements.

### DETAILED DESCRIPTION

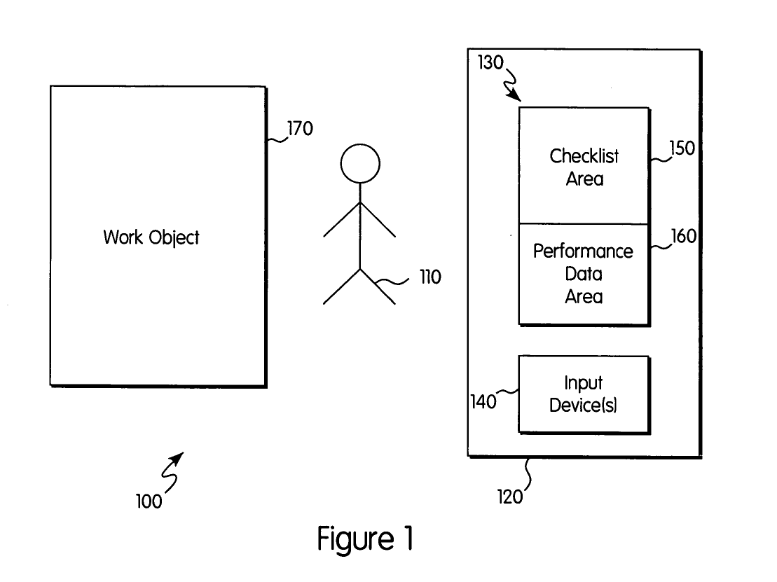

FIG. 1 shows a site 100 where a person 110 is working on a project. The person has access to a computer system 120, which in this example is a handheld computer device. The system 120 includes a display device that presents a GUI 130, and also includes input device(s) 140 by which the person can enter information into the system. The GUI 130 includes a checklist area 150 and a performance data area 160. The system can display a checklist in the area 150 that the person can use as an instruction guide during the project. Particularly, the checklist may identify predefined tasks that the person can perform. The area 160 supports user input made with the device(s) 140, which input is associated with a performed predefined task. Such user input may include performance data, for example an amount of time or material spent repairing or servicing work object 170.

The following description is based on an example wherein the work object 170 is an elevator and wherein the person 110 is an elevator service technician. Assume, therefore, that an owner of the elevator calls an elevator service firm because there is a problem with the elevator. The elevator service firm makes a preliminary assessment of the need for service, and sends the elevator service technician to the site. The technician brings the handheld computer device which contains a checklist that the technician can user as an instruction guide. That is, the elevator service firm has formulated predefined tasks for the technician to perform in servicing elevators. Such tasks may involve inspecting the elevator or replacing worn-out parts.

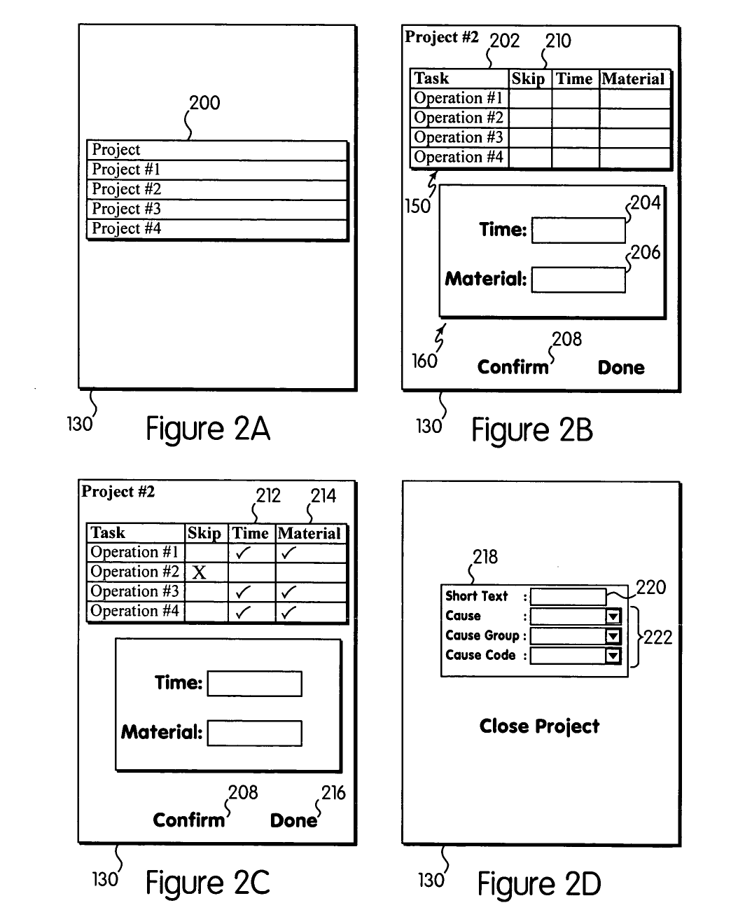

The elevator service firm charges its customers for the time and material that the elevator service technician spends working on the customers' elevators. The handheld computer device therefore is capable of documenting the tasks that the person performs. Particularly, the GUI may prompt the person to enter the amount of time or material used for the task. Examples of the GUI 130 will now be described with reference to FIGS. 2A-2D.

In FIG. 2A, there is displayed a project selection area 200 on the GUI 130. Presently, there are four separate projects (1-4) that can be initiated. For example, each of the projects 1-4 is a procedure for inspecting or servicing an elevator. Moreover, each of the projects 1-4 may be associated with a particular type of elevator malfunction. Here, the person initiates project number 2. For example, the elevator service firm instructs the technician, based on its preliminary assessment, to perform the service that corresponds to project number 2. As another example, the technician evaluates the malfunction upon arriving at the site and decides that project number 2 is the most appropriate. The person may select project number 2 using the input device(s) 140.

Upon the user initiating project number 2, the GUI 130 may present the checklist area 150 and the performance data area 160 as shown in FIG. 2B. The checklist area includes predefined tasks that are associated with the project. The predefined tasks may be designed so that they should be performed in the listed order, or the person may have authority to perform them in any order. Accordingly, the person may read the description in a Task column 202. Here, the column 202 instructs the user to perform Operation #1. For example, Operation #1 involves performing the physical operation of installing a $20 spare part on the elevator, which takes 30 minutes for the person 110.

Upon performing the first task, the person may select that task in the area 150 to begin confirmation that the task has been performed. Particularly, the performance data area 160 may prompt the user to complete a time entry field 204 and a material entry field 206. User entries in these fields will be associated with the task selected in the checklist. Accordingly, the user may enter 0.5 hour in field 204 and $20 (or the name of the spare part) in field 206. Thereafter, the user may select an input control 208 to confirm that the user has performed the task. The user may then continue by reading the description of another task in the area 150, performing that task, and subsequently entering the time and material for that task, and so on.

The checklist area may include a Skip column 210. The person can place a mark in this column for any task that the person does not perform. There may be many different reasons for non-performance, such as that the person decides it is not necessary to perform the task or that the task cannot be performed at this particular site. The system does not expect the user to enter any time or material for a skipped task. In this example, the user skips Operation #2 and performs the other three tasks (1, 3 and 4).

FIG. 2C shows what the GUI 130 may look like when the user is done with the predefined tasks. The checklist area may indicate whether the person successfully entered time and material amounts for each of the performed tasks. The checklist area includes a Time status column 212 and a Material status column 214. A checkmark in either of the columns indicates that an amount has been entered. In contrast, the absence of a checkmark in the Material status column, for example, would indicate that no material amount has been entered. This situation may occur if the person does not spend any material in performing a certain task, or if the user forgets to enter the material amount. One advantage of the GUI 130 is therefore that the person can take a quick look at the status columns 212 and 214 to determine whether all necessary information has been entered. The status columns 212 and 214 may be updated when the person confirms performance of a task using input control 208.

When the person is finished with the predefined tasks—that is, each task has either been skipped or confirmed as performed—the person may select a Done input control 216 to indicate that the project number 2 is done. The GUI 130 may then display a data entry area 218 where the person can enter additional information relating to the project. For example, the additional information may be what the person believes is the cause of the elevator malfunction. The person can enter a short written description in a text entry field 220 or select between predefined alternative causes, cause groups and cause codes listed in drop down list boxes 222.

The inputs that the person makes, such as confirming task performance or skipping tasks, and entering amounts of time and material, may be immediately transmitted to a main computer system for further processing. For example, the system 120 may be provided with wireless communication to transmit the inputs to the main computer system. In one implementation, the system 120 is a pager or cellular telephone. As another example, the system 120 may be offline from the main computer system while the person works on the project, and the received inputs may later be uploaded to the main system.

The GUI 130 is only an example. In other implementations there may be different numbers of projects, different numbers of tasks, and different numbers and categories of performance data. The Task column 202 may include longer descriptions of the tasks. As another example, different tasks of the checklist may prompt the user for different categories of performance data.

Moreover, there may be projects of many different kinds. For example, projects may relate to service, repair, performing diagnosis, performing analysis, assistance, inspection, maintenance, inventory management, and combinations thereof. That is, in any kind of project one may create a checklist of predefined tasks for a user, and the user may, upon performing any of the tasks, confirm that it has been performed and enter any performance data that is associated with performing the task. Accordingly, the work object may be many different kinds of object, or may be absent, in different implementations.

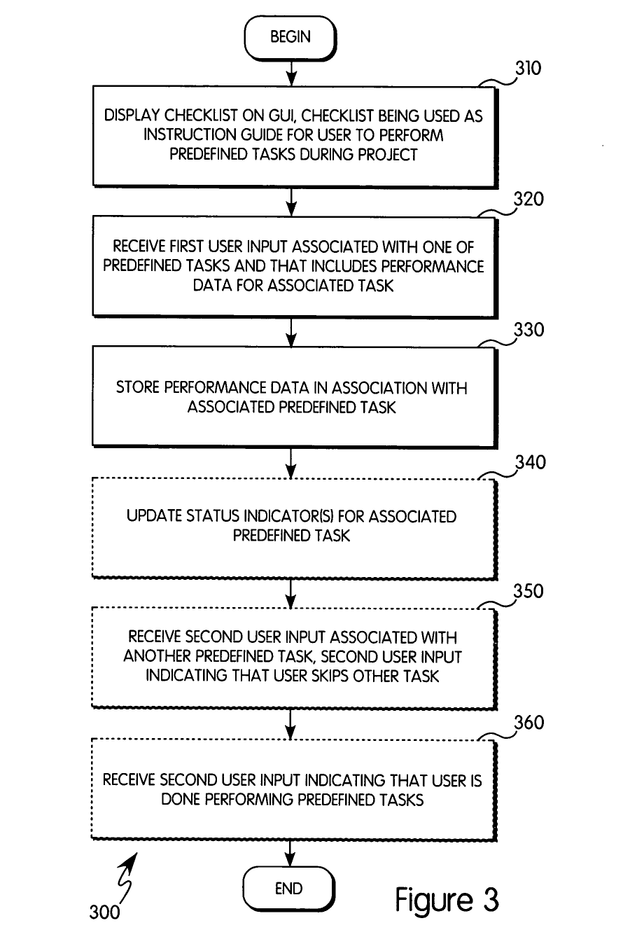

FIG. 3 is a flow chart of a method 300. The method 300 may be performed in the system 120. For example, a computer program product may include instructions that cause a processor to perform operations comprising the steps of the method 300. The method 300 includes the following steps:

Displaying, in step 310, a checklist on a GUI in a computer system. The checklist is used as an instruction guide for a user to perform predefined tasks during a project. For example, the checklist area 150 can be displayed on the GUI 130 in the system 120. The checklist may be used as an instruction guide for the person 110 to perform the Operations 1-4 during project number 2, which involves servicing an elevator.

Receiving, in step 320, a first user input in the computer system that is associated with one of the predefined tasks and that includes performance data for the associated task. For example, the system 120 may receive the user input upon the user selecting the Confirm input control 208, and the input may include performance data entered in the fields 204 and 206.

Storing, in step 330, the performance data in the computer system, the performance data being stored in association with the associated predefined task. For example, the entered time (0.5 hour) and material amount ($20) may be stored in the system 120 or in a main computer system to which they are uploaded, in association with the Operation #1. For example, the stored performance data may later be processed such that the elevator service firm can prepare an invoice that charges the customer for the person's services and the spare parts.

Updating, in optional step 340, status indicator(s) for the associated predefined task. For example, the status columns 212 and 214 may be updated to reflect that the person has successfully entered amounts of time and material for the Operation #1. The status indicator(s) may be updated upon the user selecting the Confirm input control 208.

Receiving, in optional step 350, a second user input that is associated with another one of the predefined tasks, the second user input indicating that the user skips the other one of the predefined tasks. For example, the person can place a mark in the Skip column 210 to skip the Operation #2. The mark may be placed using the input device(s) 140.

Receiving, in optional step 360, a second user input indicating that the user is done performing the predefined tasks. For example, the second user input may be received upon the user selecting the Done input control 216. Upon receiving the second input, the GUI 130 may display the data entry area 218.

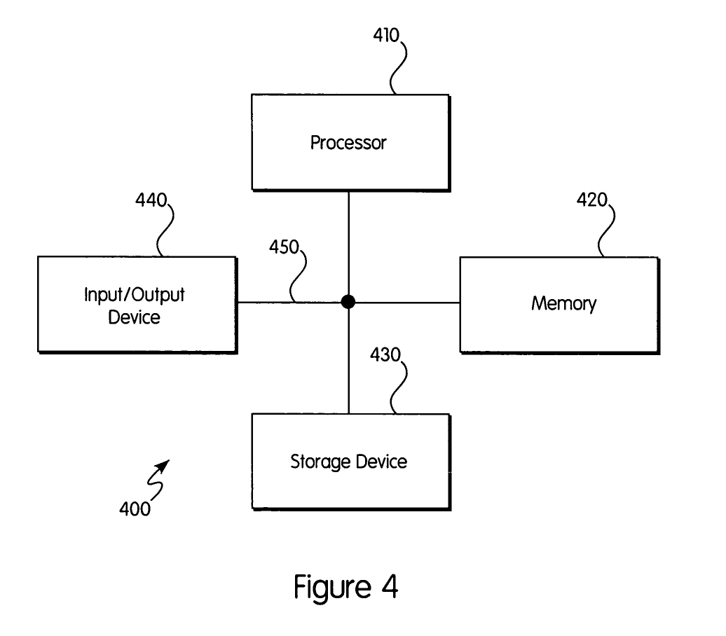

FIG. 4 is a block diagram of a computer system 400 that can be used in the operations described above, according to one embodiment. The system 400 includes a processor 410, a memory 420, a storage device 430 and an input/output device 440. Each of the components 410, 420, 430 and 440 are interconnected using a system bus 450. The processor 410 is capable of processing instructions for execution within the system 400. In one embodiment, the processor 410 is a single-threaded processor. In another embodiment, the processor 410 is a multi-threaded processor. The processor 410 is capable of processing instructions stored in the memory 420 or on the storage device 430 to display graphical information for a user interface on the input/output device 440.

The memory 420 stores information within the system 400. In one embodiment, the memory 420 is a computer-readable medium. In one embodiment, the memory 420 is a volatile memory unit. In another embodiment, the memory 420 is a non-volatile memory unit.

The storage device 430 is capable of providing mass storage for the system 400. In one embodiment, the storage device 430 is a computer-readable medium. In various different embodiments, the storage device 430 may be a floppy disk device, a hard disk device, an optical disk device, or a tape device.

The input/output device 440 provides input/output operations for the system 400. In one embodiment, the input/output device 440 includes a keyboard and/or pointing device. In one embodiment, the input/output device 440 includes a display device for displaying graphical user interfaces shown in FIGS. 2A-D above.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method of managing user tasks during a project, the method comprising:
displaying a checklist on a graphical user interface in a computer system, the checklist being used as an instruction guide for a user to perform predefined tasks during a project;
receiving, in the computer system, a first user input that is associated with one of the predefined tasks and that includes performance data for the associated predefined task; and
storing the performance data in the computer system, the performance data being stored in association with the associated predefined task.

2. The method of claim 1, further comprising receiving a second user input that is associated with another one of the predefined tasks, the second user input indicating that the user skips the other one of the predefined tasks.

3. The method of claim 1, further comprising displaying a status indicator for the associated predefined task.

4. The method of claim 3, wherein the computer system can receive multiple performance data portions for the associated predefined task, and wherein the status indicator is associated with at least one of the performance data portions.

5. The method of claim 1, further comprising receiving a second user input after receiving the first user input, the second user input indicating that the user is done performing the predefined tasks.

6. The method of claim 5, further comprising displaying, upon receiving the second user input, a data entry area where the user can enter additional information relating to performing the predefined tasks.

7. The method of claim 1, wherein the performance data includes one selected from the group consisting of: time entry data, material consumption data, and combinations thereof.

8. The method of claim 1, wherein the user performs several of the predefined tasks, further comprising prompting the user for performance data entry relating to each of the performed predefined tasks.

9. The method of claim 8, wherein the performance data entry includes different components for at least some of the performed predefined tasks.

10. The method of claim 1, wherein the checklist is displayed on a handheld computer device in the computer system, and wherein the user makes the first user input on the handheld computer device.

11. The method of claim 1, wherein the project relates to at least one selected from the group consisting of: service, repair, performing diagnosis, performing analysis, assistance, inspection, maintenance, inventory management, and combinations thereof.

12. A computer program product tangibly embodied in an information carrier, the computer program product including instructions that, when executed, cause a processor to perform instructions comprising:
display a checklist on a graphical user interface in a computer system, the checklist being used as an instruction guide for a user to perform predefined tasks during a project;
receive, in the computer system, a first user input that is associated with one of the predefined tasks and that includes performance data for the associated predefined task; and
store the performance data in the computer system, the performance data being stored in association with the associated predefined task.

13. A computer program product tangibly embodied in an information carrier, the computer program product including instructions that, when executed, generate on a display device a graphical user interface for managing user tasks during a project, the graphical user interface including:
a checklist area that identifies predefined tasks, the checklist area being used as an instruction guide for a user to perform the predefined tasks during a project; and
a performance data area that displays performance data for one of the predefined tasks, the performance data being entered by the user for storage in association with the one of the predefined tasks.

14. The computer program product of claim 13, wherein the graphical user interface further includes an input control for the user to skip any of the predefined tasks.

15. The computer program product of claim 13, wherein the graphical user interface further includes a status indicator for each of the predefined tasks, which status indicator can be updated upon the user confirming performance any of the predefined tasks.

16. The computer program product of claim 15, wherein the graphical user interface further includes multiple status indicators for each of the predefined tasks, each of the status indicators being associated with a portion of the performance data.

17. The computer program product of claim 13, wherein the graphical user interface is displayed on a handheld computer device, and wherein the user enters the performance data on the handheld computer device.

18. The computer program product of claim 13, wherein the predefined tasks relate to at least one selected from the group consisting of: service, repair, performing diagnosis, performing analysis, assistance, inspection, maintenance, inventory management, and combinations thereof.

19. The computer program product of claim 13, wherein the predefined tasks comprise the user performing physical operations.
